(19) United States
(12) Patent Application Publication
(10) Pub. No.: US 2005/0276546 A1
(43) Pub. Date: Dec. 15, 2005

(54) Bidirectional emitting and receiving module

(76) Inventors: Martin Weigert, Hardt (DE); Bernhard Bachl, Falkensee (DE)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 11/144,892

(22) Filed: Jun. 3, 2005

Related U.S. Application Data
(63) Continuation of application No. PCT/DE02/04492, filed on Dec. 4, 2002.

(51) Int. Cl. G02B 6/36

(52) U.S. Cl. 385/89

(57) ABSTRACT

The invention relates to a bidirectional emitting and receiving module and includes a support having a top face and a bottom face, an emitting component disposed on the top face that emits light having a first wavelength, and a receiving component arranged on the bottom face that receives light having a second wavelength. The support includes a slanted boundary surface that is coated with a wavelength-selective mirror, and light emitted by the emitting component is reflected and deflected on the mirror, while light that is emitted by the emitting component and is to be received by the receiving component is refracted thereon into the adjacent medium. Such light is refracted on the boundary surface, penetrates the support, and leaves the support on the bottom face thereof, and is then detected by the receiving component.

### RELATED APPLICATION

This application is a continuation of International Application No. PCT/DE02/04492 filed Dec. 4, 2002, which was not published in English, and which is hereby incorporated by reference in its entirety.

### FIELD OF THE INVENTION

The invention relates to a bidirectional emitting and receiving module, which emits light having a first wavelength and detects light having a second wavelength. WDM (wavelength division multiplex) applications constitute an exemplary area of use.

### BACKGROUND OF THE INVENTION

Bidirectional emitting and receiving modules are known per se. The known solutions have the disadvantage that the emitting components and receiving components of the modules are in each case realized on separate carriers and/or with separate housings.

EP 0 664 585 A1 discloses an emitting and receiving module for bidirectional optical message and signal transmission. In this case, a laser chip is arranged on a carrier in such a way that it emits radiation onto a slanted interface of an additional body arranged on the carrier. The emitted radiation is deflected at the interface, passed through a lens coupling optical element fitted above the laser chip and the interface, and is coupled into an optical fiber. Beneath the carrier, a photodetector is arranged in a TO housing baseplate and detects radiation that emerges from the optical fiber. The received radiation is directed onto the interface via the lens coupling optical element and passes through the interface and the carrier.

U.S. Pat. No. 5,577,142 discloses an emitting and receiving communication means for optical fibers. The communication means has a total of three carriers arranged in parallel one above the other. On the topmost carrier a photodiode is arranged as a receiver. A laser diode operating as an emitter and a monitor diode for measuring a reference signal are integrated between the three carriers.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present one or more concepts of the invention in a simplified form as a prelude to the more detailed description that is presented later.

The present invention is directed to a bidirectional emitting and receiving module that is distinguished by a compact construction and a high degree of integration.

Accordingly, the emitting and receiving module according to the invention has a carrier, on the top side of which an emitting component is arranged and at the underside of which a receiving component is arranged. In this case, the carrier is transparent to the light to be detected by the receiving component. A slanted interface coated with a wavelength-selective mirror is provided, at which, on the one hand, light emitted by the emitting component is reflected and deflected. On the other hand, at the slanted interface, light to be received by the receiving component is refracted into the adjoining medium. The light to be received that is refracted at the interface traverses the carrier, emerges from the carrier at the underside thereof and is then detected by the receiving component. The receiving component is arranged in a cutout in the underside of the carrier. The cutout is deep enough, in one example, to completely accommodate the receiving element. In particular, the cutout is designed such that a receiving component with a chip thickness of 80 μm to 200 μm can be mounted in the cutout.

The cutout is formed by a trench or a truncated pyramid, for example, which is preferably formed by etching in the carrier. In principle, a trench may in particular also be provided by means of mechanical methods such as milling.

The solution according to one embodiment of the invention is constructed extremely compactly since the emitting component and the receiving component are arranged on only one carrier. In this case, a beam path is provided which enables the received light to emerge on the rear side of the carrier, so that the receiving component can be arranged there. The emergence of the received light from the rear side of the carrier, that is to say the avoidance of any total reflection, is achieved by means of the received light impinging as far as possible perpendicularly on the underside of the carrier. For this purpose, on the one hand, by means of the refractive index of the materials used, it is possible to influence the direction of the light refraction at the slanted interface and thus the direction of light propagation in the carrier. On the other hand, it is possible to provide, if appropriate, slanted cutouts on the rear side of the carrier.

It is pointed out that the arrangement of the receiving component “at the underside” of the carrier should be understood such that the receiving component may be fixed directly to the underside of the carrier but may also be spaced apart from the underside and merely arranged beneath the carrier. There does not have to be any physical contact between carrier and the receiving component.

In one embodiment of the invention, the module has an additional body, which may be a glass body, in particular a glass prism. The additional body is arranged on the carrier and forms the slanted interface with the wave-selective mirror, the light to be received that is refracted at the interface thus traversing the additional body first and then the carrier. In this case, the additional body constitutes a unit that can be coated separately with the wavelength-selective mirror.

In another embodiment, the receiving component is assigned a wavelength-selective filter which is situated at the underside of the carrier and blocks the transmission of light having the first wavelength. The wavelength-selective filter is preferably a high-pass filter or a low-pass filter that transmits or blocks wavelengths in the window of 1,480 to 1,600 nm.

In a further embodiment, the cutout at the underside of the carrier is provided with metallizations. In this case, the receiving component is mounted by flip-chip mounting in the cutout, for which purpose both contacts are arranged on one side. Flip-chip mounting avoids the use of a bonding wire that would disadvantageously project from the cutout in which the receiving component is arranged.

In a further embodiment of the invention, the slanted interface is not formed at an additional body but rather at the carrier itself. This refinement thus manages without a further part that would have to be connected to the carrier. Rather, the slanted interface at which the light of the emitting component is reflected and the light to be detected is refracted into the adjoining medium is integrated into the carrier.

In this case, the slanted interface is formed at the bevel of a cutout at the top side of the carrier. The emitting component is then arranged in the cutout. Another, opposite bevel of the cutout may serve as a beam deflecting unit for a monitor diode that is assigned to the emitting component and detects the rear-side radiation of the laser diode for monitoring purposes. In this case, the monitor diode is arranged on the topmost plane of the top side of the carrier.

In a variation of this embodiment, the underside of the carrier is oriented with regard to the direction of propagation of the light to be received in the carrier in such a way that the light to be received, after traversing the carrier, does not experience any total reflection at the underside of the carrier and can be detected by the receiving component. For this purpose, it may be provided that the carrier has on its underside a cutout with a bevel, from which the light to be received emerges.

In this case, the bevel may serve as a carrier of a wavelength-selective filter which blocks the transmission of light having the first wavelength. The wavelength-selective filter may be formed either at the bevel itself or at a separate carrier, which may be fixed to the bevel by means of an index-matched, transparent adhesive. It is also conceivable for the receiving component to be arranged directly at the bevel. The considered bevel of the cutout at the rear side of the carrier runs parallel to the slanted interface with the wavelength-selective mirror at the top side of the carrier, both running at an angle of 45° with respect to the mounted area of the emitting component. Consequently, two parallel planes are produced in the carrier in this example.

In order to produce the module, it may be provided that the top side of the carrier is formed from a first patterned wafer and the underside of the carrier is formed from a second patterned wafer, which are connected to one another after the patterning by means of wafer fusing. In this case, a unit that can be tested by panel mounting is formed, in the case of which the modules are tested prior to singulation of the wafer.

The carrier, in one example, is composed of silicon. The slanted interface may run at an angle of 45° with respect to the plane of the top side of the carrier, the slanted interface being formed either at an additional element, in particular a glass prism, or in the silicon substrate itself. The respective bevels in one example are produced micromechanically by etching.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The invention is explained in more detail below on the basis of a number of exemplary embodiments with reference to the figures of the drawings, in which:

FIG. 1 is a sectional view illustrating a first exemplary embodiment of a bidirectional emitting and receiving module;

FIG. 2 is a sectional view illustrating a wafer for producing an emitting and receiving module in accordance with FIG. 1;

FIG. 3 is a sectional view illustrating the emitting and receiving module of FIG. 1, particularly the submount and the glass prism of the module and also the layers, mirrors and filters arranged thereon;

FIG. 4 is a bottom plan view illustrating the emitting and receiving module of FIG. 3;

FIG. 5 is a top plan view illustrating the emitting and receiving module of FIG. 3;

FIG. 6 is a sectional view illustrating a housing arrangement with an emitting and receiving module in accordance with FIGS. 1 to 5,

FIG. 7 is a sectional view illustrating an alternative exemplary embodiment of an emitting and receiving module, a glass or silicon lamina with a blocking filter being arranged at a bevel at the underside of the module carrier;

FIG. 8 is a sectional view illustrating an emitting and receiving module corresponding to the emitting and receiving module of FIG. 7, in which case, instead of a glass or silicon lamina with a blocking filter, a blocking filter layer is applied directly to the bevel at the underside of the module carrier;

FIG. 9 is a sectional view illustrating a wafer for producing the emitting and receiving module of FIGS. 7 and 8; and

FIG. 10 is a sectional view illustrating a housing arrangement with an emitting and receiving module in accordance with FIGS. 7 and 8.

### DETAILED DESCRIPTION OF THE INVENTION

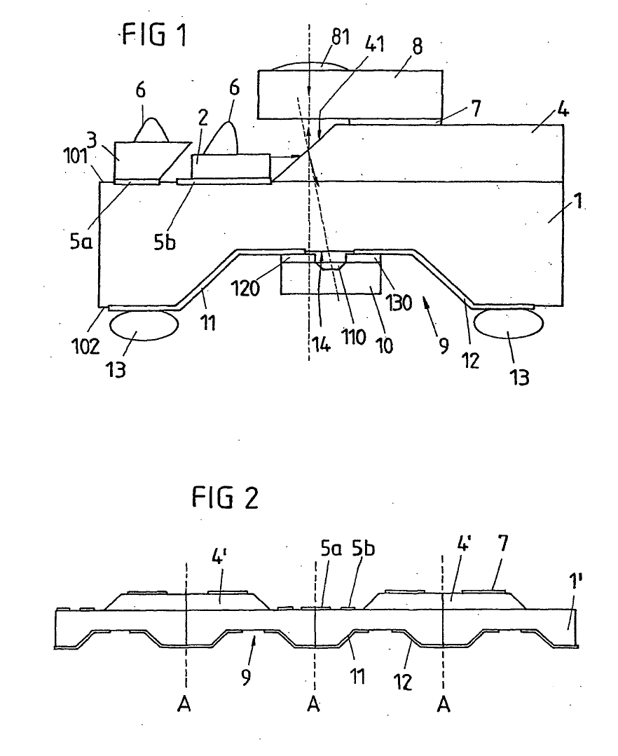

FIGS. 1 to 6 show a first exemplary embodiment of a bidirectional emitting and receiving module. As can be gathered from FIG. 1, in particular, the emitting and receiving module has a carrier 1, which is also referred to hereinafter as a submount and is composed of silicon in the exemplary embodiment illustrated. The submount 1 has a top side 101 and an underside 102, which run parallel—apart from cutouts introduced into the respective surface.

A laser diode 2, a monitor diode 3 and a glass prism 4 are arranged on the top side 101 of the submount 1. Metallizations 5a, 5b and bonding wires 6 are provided for the purpose of contact-connecting the laser diode 2 and the monitor diode 3. The laser diode 2 is formed as a laterally emitting laser. In this case, a small percentage of the laser light is coupled out on the rear side and detected by the monitor diode 3 for monitoring purposes.

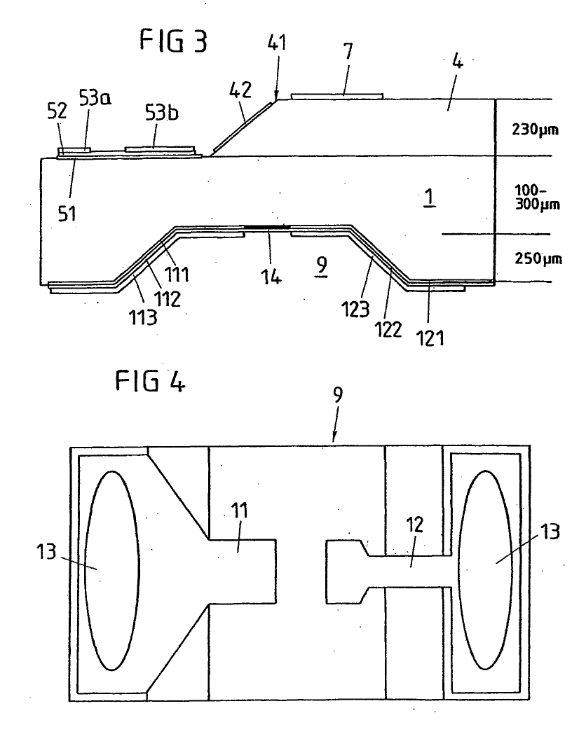

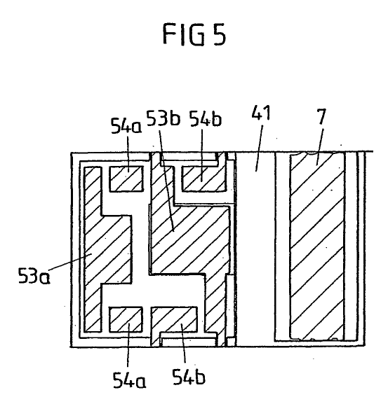

The glass prism 4 has an interface 41 running at an angle of 45°, said interface being coated with a wavelength-selective mirror 42 (cf. FIG. 3). A silicon element 8 having an etched silicon lens 81 is fixed on the surface of the glass prism 4 by means of a metallization 7. In this case, the silicon lens 81 is situated above the slanted interface 41 of the glass prism 4.

The underside of the silicon submount 1 has a cutout 9, which is introduced into the silicon carrier 1 micromechanically by etching. A photodiode 10 with a photosensitive area 110 is situated in the cutout 9. A p-type contact 120 and an n-type contact 130 are arranged on the same side of the photodiode 10, so that it is possible to effect a flip-chip mounting of the photodiode 10 on metallizations 11, 12 at the walls of the cutout 9.

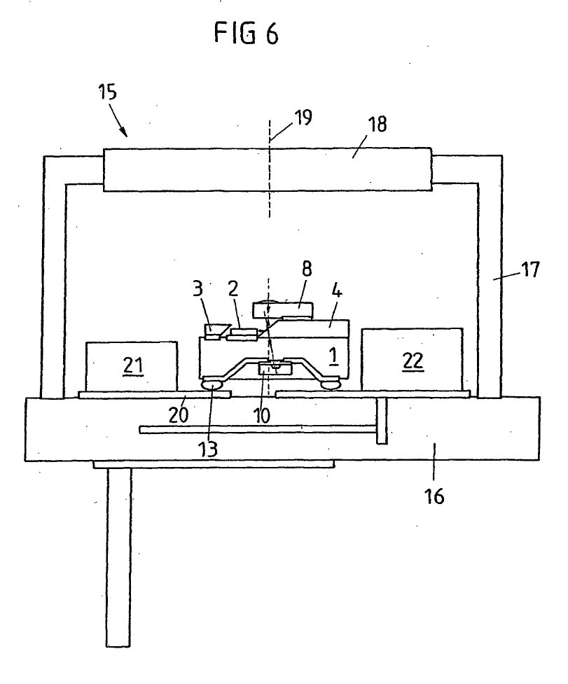

On the underside 102 of the submount 1, solder bumps 13 are arranged on the metallizations 11, 12, and serve for an SMD mounting of the entire module on a ceramic board, for example, as will also be explained with reference to FIG. 6.

FIG. 2 shows a silicon wafer 1′ with glass prisms 4′ fixed to the top side thereof and with the metallizations 5a, 5b, 7, 11, 12 prior to singulation. The singulation is effected along the section lines A. In this example, a singulation is performed only when the components explained in FIG. 1 are arranged on the silicon wafer 1′ or the respective glass prisms 4′, so that it is possible to implement a test of the individual modules on the wafer prior to singulation.

FIG. 3 shows more clearly the individual metallizations, filters and mirrors which are provided on the submount 1 and the glass prism 4. Accordingly, on the region of the submount 1 on which the laser diode 2 and the monitor diode 3 are mounted, provision is made of firstly an oxide layer 51 (e.g., SiO₂), over that a nitride layer (52 e.g., Si3N4) and, adjoining that, in each case a metallization 53a, 53b (e.g., TiPtAu). The wavelength-selective mirror 42 (WDM mirror) is arranged on the slanted interface 41 of the glass prism 4, which mirror reflects the light emitted by the laser diode 2 and transmits light to be detected by the photodiode 10. Situated on the top side of the glass prism 4 is the metallization layer 7 (e.g., CrPtAu or TiPtAu) for fixing the silicon element 8 with the lens 81.

The underside of the submount 1 firstly has a wavelength-selective filter (blocking filter 14) centrally in the cutout 9, which filter is not transmissive to light of the emitting diode 2 and accordingly blocks this light from the photodiode 10. The blocking filter 14 is preferably either a high-pass filter or a low-pass filter. If the bidirectional module is in this case designed such that the laser 2 emits in the window between 1,260 and 1,360 nm and the photodiode 10 arranged in the cutout 9 detects light having a wavelength in the window of 1,480 to 1,600 nm, then the blocking filter 14 would in this case be embodied as a high-pass filter that blocks the lower wavelengths of 1,260 nm to 1,360 nm and transmits wavelengths starting from 1,480 nm. In the case of a contrasting bidirectional module, which then emits at 1,480 to 1,600 nm, and receives at 1,260 to 1,300 nm, a low-pass filter is provided in a corresponding manner.

Furthermore, an oxide layer 111, 121, a nitride layer 112, 122 and a metallization 113, 123 are once again formed on the underside of the submount 1, and extend along the wall of the cutout 9. It can be gathered from the bottom view of FIG. 4 that the metallization in the cutout 9 is designed in such a way that one contact area 12 for the p-type contact has a smallest possible area in order to keep down the electrical capacitance of the receiving unit. By contrast, the second contact area 11 for n-type contact is designed with the largest possible area in order to ensure a good thermal conductivity. This thermal conductivity is necessary in order that the heat which is generated by the laser chip 2 and radiates into the silicon substrate 1 can be dissipated well from the silicon substrate 1.

FIG. 4 likewise illustrates the soldering bumps 13 that are arranged on the underside of the submount 1 and serve for further mounting of the module on a carrier. Adhesive bonding is also possible in this case instead of soldering bumps.

FIG. 5 shows a plan view of the top side of the submount 1 and the glass prism 4. The soldering area or metallization 53a for the monitor diode 3 and the soldering area or metallization 53b for the laser diode 2 can be discerned. Further metallizations 54a, 54b serve for mounting of the bonding wires 6. With regard to the glass prism, the bevel 41 running at an angle of 45° and the metallization 7 for the silicon part with the lens 81 can be discerned.

The function of the emitting and receiving module described is as follows. Light having a first wavelength that is emitted by the laser diode 2 is reflected at the wavelength-selective mirror 42 of the interface 41—running at an angle of 45°—of the glass prism 4 and radiated perpendicular to the surface 101 of the submount. In this case, the reflected laser light passes through the lens 81 arranged above the bevel 41 and is subsequently coupled into an optical fiber. Light having a second wavelength that is coupled out from the corresponding optical fiber and runs in the opposite direction and is to be detected by the photodiode 10 falls through the lens 81 onto the bevel 41 of the glass prism. Since the wavelength-selective mirror 42 is transmissive to the reception wavelength, the light to be received is refracted into the glass prism 4.

In this case, the light is refracted toward the perpendicular on account of the fact that the glass prism 4 has a higher refractive index than air. The light to be received then traverses the glass prism 4 and subsequently enters into the silicon submount 1, which is transparent to the wavelengths considered (above 1 000 nm). In this case, the glass prism 4 is connected to the silicon submount 1 by anodic bonding, by way of example, the refractive index of the glass increasing in the boundary layer of the glass prism 4 with respect to the silicon carrier 1 as a result of indiffused ions and, at the interface, being equal to the refractive index of the adjoining silicon carrier 1, so that the light is not refracted upon the transition between the glass prism 4 and the silicon carrier 1. The light to be received then traverses the silicon carrier 1 and emerges from the silicon carrier 1 at the underside in the region of the cutout 9. The photodiode 10 is arranged in the cutout 9 in such a way that the photosensitive area 110 is irradiated with the light to be received. The light to be detected passes through the blocking filter 14 prior to detection, so that any possible scattered light from the photodiode 2 is coupled out.

It is pointed out that the light to be received, on account of the refractive index of the glass prism 4, is coupled into the glass prism and subsequently into the silicon submount in such a way that it does not experience any total reflection at the underside of the silicon submount 1 and can accordingly be detected by the photodiode 10. The refractive index of the glass prism 4 thus results in a beam path that enables the light to emerge from the plane underside 101 of the silicon submount 1.

FIG. 6 shows the previously described emitting and receiving module in the arrangement in a housing 15. The housing 15 has a multilayer baseplate 16 made of ceramic, a cap 17 and a plane glass window 18. The plane glass window 18 constitutes a light entry/exit opening of the housing, to which an optical fiber is coupled along the axis 19. In this case, the light emitted by the emitting diode 2 is coupled into such an optical fiber. At the same time, light that has been emitted by a correspondingly constructed emitting and receiving module at the other end of an optical link is coupled out from the optical fiber. This coupled-out light is detected by the receiving diode 10 as described. The emitting and receiving module is arranged on metallizations 20 of the baseplate by means of the soldering bumps 13. The baseplate 16 furthermore carries a transimpedance amplifier 21 for preamplifying the signals detected by the photodiode 10, and SMD capacitors 22.

Overall, a highly compact arrangement is provided in the case of which the emitting diode 2 and the receiving diode 10 are arranged on a common carrier and this carrier is situated in only one housing, into which light is coupled in and out via an optical coupling.

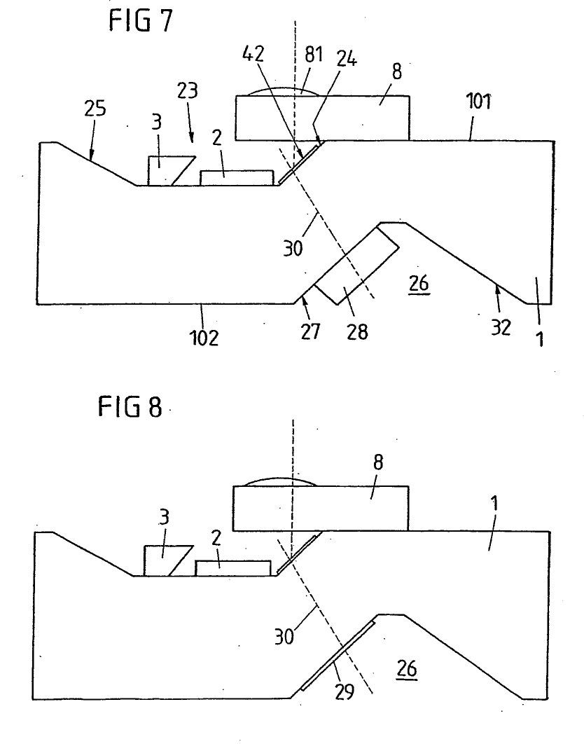

FIGS. 7 to 10 show a second exemplary embodiment of a bidirectional emitting and receiving module. In this case, identical reference signals identify corresponding structural parts. The embodiment of FIGS. 7 to 10 is explained only insofar as there are differences relative to the exemplary embodiment of FIGS. 1 to 6.

One difference of this embodiment is the fact that the exemplary embodiment of FIGS. 7 to 9 manages without a glass prism. Instead, the slanted interface with the wavelength-selective mirror 42 is formed at the carrier 1 itself. For this purpose, the silicon carrier 1 has at its top side 101 a cutout 23 which has the form of a trench or a pit and which is produced by etching the silicon substrate 1. The cutout 23 forms two opposite bevels 24, 25. The right-hand bevel 24 assigned to the laser diode 2 is etched at an angle of 45° and corresponds in terms of its function to the interface 41 of the glass prism 4 of FIGS. 1 to 6. The wavelength-selective mirror 42 is arranged on the bevel 24.

The opposite bevel 25 in one example has an oblique angle of 63°, which results from the crystal orientation of the silicon. In a development of the exemplary embodiment illustrated, the 63° bevel 25 may serve as a beam deflecting unit for the rear-side radiation of the laser, a monitor diode then being mounted above the bevel 25 on the surface 101 of the carrier. In this configuration, then, unlike in the configuration illustrated, the monitor diode would not be arranged in the cutout 23. This may be expedient particularly when the cutout is relatively small.

The silicon element 8 with the lens 1 is arranged directly on the carrier 1.

A cutout 26 is once again also formed on the underside 102 of the silicon carrier 1. Said cutout likewise has two bevels 27, 32. The left-hand bevel 27 is likewise introduced into the silicon substrate by etching at an angle of 45°. The two 45° faces 24, 27 accordingly lie on the top side and underside of the substrate 1 in parallel planes. In principle, however, this need not be the case and the orientations of these two planes 24, 27 can also deviate from one another. It should be taken into account in this case that, in particular, the cutout 27 can also be produced by sawing or abrasive cutting instead of by etching, so that there is a greater freedom of choice with regard to the angle of the bevel 27.

In the light exit region, a glass or silicon lamina 28 is mounted at the bevel 27 said lamina being provided with a blocking filter which, in accordance with the explanations above, is formed as a high-pass filter or low-pass filter. If the cutout 26 is produced by sawing or abrasive cutting, the lamina 24 may be adhesively bonded on by means of a transparent adhesive. In this case, the adhesive is preferably index-matched, so that it performs the function of an immersion liquid or a matching gel, thereby minimizing the influence of the sawing roughness on the radiation. In the exemplary embodiment of FIG. 8, a separate glass or silicon lamina 24 is not used and the blocking filter 29 is instead applied directly to the bevel 27 of the cutout 26.

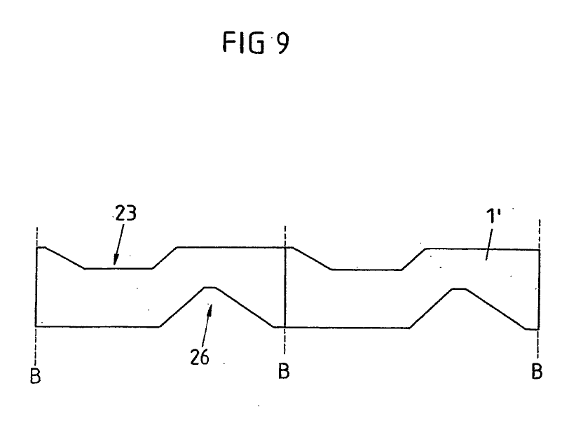

FIG. 9 shows a sectional illustration of the silicon wafer 1′ prior to singulation along sawing lines B.

The beam path of the laser diode 2 corresponds to the beam path of the exemplary embodiment of FIGS. 1 to 6. By contrast, a different beam path 30 results for the receiving radiation on account of the higher refractive index of silicon compared with glass. On account of the higher refractive index, the radiation to be received is refracted toward the perpendicular to the interface 24 to a greater extent, so that the radiation to be received takes a more inclined course in the silicon substrate 1. This would have the effect that the radiation, if no cutout 26 were provided, would fall onto the plane underside 102 of the carrier 1 at an angle greater than the angle of total reflection. The radiation could not then emerge from the silicon carrier at all.

Therefore, the cutout 26 with the bevel 27 is introduced into the silicon substrate 1. The light to be received emerges from the silicon substrate through the bevel 27, in which case, on account of the angular arrangement of the bevel 27, the light can emerge and does not experience any total reflection.

The greater refraction of the light to be received in the silicon substrate is thus compensated for by providing a bevel at the underside of the carrier, from which the light to be received emerges. The light exit plane 27 provided by the cutout 26 is designed such that the critical angle of total reflection in the silicon does not occur at the wavelengths considered of between 1,260 and 1,600 nm if the radiation enters into the silicon carrier 1 via the 45° beam splitter 24. The carrier described is produced for example by etching of a corresponding silicon wafer on the top side and underside and subsequent provision of the metallizations, filters and mirrors and also of the components described. In this case, a preliminary test is preferably effected prior to singulation. However, it is likewise possible to pattern two silicon wafers independently of one another respectively with the structure of the top side 101 and the structure of the underside 102 and to subsequently connect the two wafers to one another by means of wafer fusing. The further production is then effected as described above.

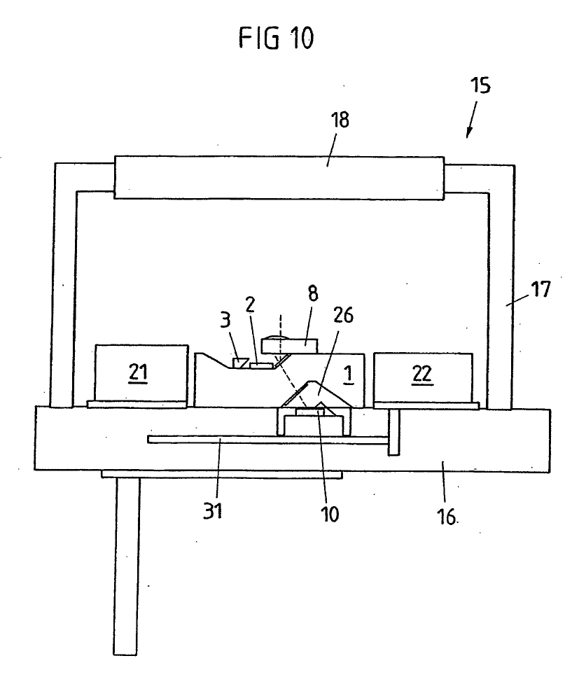

Finally, FIG. 10 shows the arrangement of the bidirectional emitting and receiving module in a housing 15, which is formed in a manner corresponding to the housing 15 of FIG. 6. However, in this case the photodiode 10 is not arranged directly at the underside of the silicon carrier 1. It is, however, situated beneath the silicon carrier 1 in a position such that the light that has emerged from the carrier 1 from the bevel 27 falls onto the light-sensitive area of the photodiode. The photodiode is contact-connected to a multilayer baseplate 16 via a metallization 31.

In an alternative configuration, however, it may also be provided that the monitor diode is arranged directly at the light exit area or bevel 27 of the carrier substrate 1. Such a configuration is expedient particularly in the case of small-area photodiodes and/or relatively large cutouts 26 at the underside of the silicon carrier 1.

While the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention.

In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

1. A bidirectional emitting and receiving module, comprising:
a carrier comprising a top side and an underside;
an emitting component arranged at the top side of the carrier and configured to emit light having a first wavelength;
a receiving component arranged at the underside of the carrier and configured to receive light having a second wavelength, wherein the carrier is transparent to the light having the second wavelength; and
a slanted interface coated with a wavelength-selective mirror, and spatially configured with respect to the top side of the carrier such that light emitted by the emitting component is reflected and deflected at the interface and light to be received by the receiving component is refracted into the carrier,
wherein the received light that is refracted at the interface traverses the carrier and emerges from the carrier at the underside thereof and is detected by the receiving component, and
wherein the underside of the carrier comprises a cutout comprising a sufficient depth to completely accommodate the receiving component arranged therein.

2. The module of claim 1, wherein the slanted interface comprises a glass prism arranged on the top side of the carrier, wherein the received light that is refracted at the interface traverses the glass prism first and then traverses the carrier.

3. The module of claim 2, wherein the glass prism and the carrier are connected to one another by anodic bonding.

4. The module of claim 2, wherein the glass prism is configured to refract the received light at an angle such that after traversing the carrier the received light does not experience any total reflection at the underside of the carrier and thus is detected by the receiving component.

5. The module of claim 1, wherein the receiving component further comprises a wavelength-selective filter situated at the underside of the carrier and configured to block the transmission of light having the first wavelength.

6. The module of claim 5, wherein the wavelength-selective filter comprises a high-pass filter or a low-pass filter.

7. The module of claim 1, wherein the cutout associated with the underside of the carrier contains metallizations therein configured to facilitate a flip-chip mounting of the receiving component to the carrier.

8. The module of claim 7, wherein the metallizations comprise a p-type contact area and an n-type contact area configured to contact the receiving component, wherein one of the contact areas comprises a comparatively small area and the other of the contact areas comprises a comparably large-area design.

9. The module of claim 2, further comprising a beam-shaping optical element through which the emitted and received light radiates before and respectively after coupling into and out of an optical waveguide operably coupled to the module, wherein the beam-shaping optical element is arranged above the slanted interface.

10. The module of claim 1, wherein the slanted interface is a portion of the top side of the carrier.

11. The module of claim 10, wherein the slanted interface comprises a bevel portion of a cutout in the top side of the carrier, and wherein the emitting component is arranged in the top side cutout.

12. The module of claim 11, wherein the top side cutout further comprises an opposite bevel configured to deflect light from the emitting component to a monitor diode associated with the emitting component, wherein the monitor diode is arranged on a topmost plane of the top side of the carrier.

13. The module of claim 11, wherein a partial region of the underside cutout of the carrier is oriented with regard to a direction of propagation of the received light through the carrier such that the received light, after traversing the carrier, does not experience any total reflection and is detected by the receiving component.

14. The module of claim 13, wherein the partial region comprises a bevel, and further comprising a wavelength-selective filter residing on the bevel and configured to block the transmission of light having the first wavelength.

15. The module of claim 14, wherein the wavelength-selective filter resides on a separate carrier that is fixed to the bevel by means of an index-matched, transparent adhesive.

16. The module of claim 14, wherein the receiving component is arranged at the bevel.

17. The module of claim 14, wherein the bevel of the underside cutout runs parallel to the slanted interface at the top side, and wherein the two bevels are both oriented at an angle of about 45° with respect to a mounted area of the emitting component.

18. The module of claim 10, wherein the top side of the carrier is formed from a first patterned wafer and the underside of the carrier is formed from a second patterned wafer, and wherein the first and second patterned wafers are connected to one another after the patterning thereof by means of wafer fusing.

19. The module of claim 1, wherein the carrier comprises silicon.

20. The module of claim 1, wherein the slanted interface is oriented at an angle of about 45° with respect to a plane associated with the top side of the carrier.

21. The module of claim 1, wherein the emitting component comprises a laterally emitting laser diode, and wherein the emitted radiation falls directly onto the slanted interface.

22. The module of claim 1, further comprising a housing in which the carrier is arranged, the housing comprising a multilayer ceramic baseplate provided with metallizations and a cap comprising a light entry/exit window for transmission of radiation therethrough.
